(19) United States
(12) Patent Application Publication
(10) Pub. No.: US 2025/0206646 A1
(43) Pub. Date: Jun. 26, 2025

(54) PROCESS FOR TREATMENT OF MINE CONTACT WATER

(71) Applicant: Teck Resources Limited, Vancouver (CA)

(72) Inventor: Jose Alberto GONZALEZ, Trail (CA)

(21) Appl. No.: 18/852,089

(22) PCT Filed: May 19, 2023
(86) PCT No.: PCT/CA2023/050694

§ 371 Date: Sep. 27, 2024

Related U.S. Application Data
(60) Provisional application No. 63/345,881, filed on May 25, 2022.

(51) Int. Cl. C02F 9/00; C02F 1/44; C02F 1/66; C02F 101/10; C02F 101/16; C02F 103/10

(52) U.S. Cl. CPC C02F 9/00; C02F 1/441; C02F 1/442; C02F 1/66; C02F 2101/101; C02F 2101/106; C02F 2101/163; C02F 2103/10; C02F 2301/046

(57) ABSTRACT

A process for treating high alkalinity Mine Contact Water (MCW) includes providing the MCW to a feed stream, adding acid to the feed stream to provide a reduced pH and alkalinity feed stream, subjecting the reduced pH and alkalinity feed stream to filtration and a membrane treatment to separate the reduced pH and alkalinity feed stream into permeate and brine, subjecting the brine to a high density sludge (HDS) process to produce a processed brine and residues; recycling a majority of the processed brine to the feed stream, separating a minor fraction of the processed brine to provide a bleed off of the processed brine prior to the recycling, and subjecting the bleed off of the processed brine to a subsequent treatment to remove at least some contaminants.

### TECHNICAL FIELD

The present application relates to the treatment of Mine Contact Water, for example, for removal and management of total dissolved solids and of constituents of concern.

### BACKGROUND

Mine Contact Water (MCW) is water that has been impacted by a mining operation. Such water may include run-off water that has contacted waste rock dumps generated during mining of coal, copper, or zinc. Over time chemical and biological processes can become established within waste rock dumps, gradually releasing constituents of concern from the waste rock to the MCW.

Selenium, one constituent of concern, may be present in MCW and management and removal of selenium from MCW is desirable due to possible effects that selenium, above certain concentrations, may have on aquatic life and organisms.

Often, it is desirable to separate some of the constituents of the MCW such as dissolved selenium, nitrate, and other constituents of concern present in the MCW to provide a purified water effluent.

U.S. Pat. No. 3,795,609 by Hill et. al. (referred to herein as Hill) describes a process in which reverse osmosis (RO) membranes are used to treat acid mine drainage water (AMD) with elevated concentrations of Fe (up to 10 mg/L), Al (up to 2 mg/L) and SO₄ (up to 50 g/L) and low pH (1.5 to 6). According to Hill, AMD is pre-treated prior to filtration and treatment in the Reverse Osmosis (RO) membrane treatment. Acidic brine (pH ˜2.4) produced in the RO step is treated in a neutralization step in which an alkaline reagent (e.g., lime) is added to raise the pH (to ˜4.4) of the brine and precipitate some of the compounds present in the brine (e.g., sulphate, iron, aluminium). The neutralized brine obtained after solid/liquid separation (referred to as “neutralized brine”) is recycled to the front end of the process to be blended with additional pre-treated AMD, then the blended water is filtered, and fed to the RO system. Residues are disposed of, for example, in a landfill. The brine neutralization step is carried out at low pH (pH ˜4.5) to prevent precipitation of iron compounds upon blending the neutralized brine with fresh AMD. A low pH (pH 2.2 to 2.7) in the blended water fed to the RO step is utilized to prevent excessive precipitation of Fe and Al compounds in the membranes. Recycling of the neutralized brine allows for high overall water recoveries, as high as 97.7% obtained in one of the examples. However, accumulation of some compounds in the blended water fed to RO was observed. Ca, Fe, Al, Mg, and SO₄ concentrations were all reported to be higher in the blended water fed to the RO step than in the AMD. Two end streams were produced from the treatment of mineral contaminated water, including a generally inert sludge and a purified product stream.

Tests described by Hill were carried out over several days of operation (maximum 130 h). Thus, over several months of operation, increasing accumulation of some components in the blended water fed to the RO step is expected to be problematic and to present fouling problems in the RO membranes. This fouling results in requiring operation at increasingly higher applied pressures in the RO step, and more frequent membrane cleaning.

Hill teaches producing a brine that is significantly desaturated of scaling compounds and other components in a dedicated step, and then the neutralized brine is recycled to the front end of the process to be blended with fresh water to be fed to the membrane step, with the objective of maximizing water recovery and preventing and minimizing operational issues in the membranes. Hill teaches that neutralized brine is processed via multiple cycles of blending, filtration, reverse osmosis, and neutralizing steps.

Improvements and variations of the process taught by Hill have been proposed with the objective to treat different types of water, maximize water recovery and product water purity, and desaturate and treat the neutralized brine. Such variations are described in, for example, U.S. Pat. Nos. 5,501,798 and 6,461,514 to Al-Samadi et. al, and in PCT patent application publication number WO 2010/033674 to Alexander et. al.

Use of nested flowsheets to achieve high water recoveries is described in United States patent application publication 2011/0155665, to Cohen et. al., in U.S. Pat. No. 9,969,629 to Eda et. al., and in U.S. Pat. No. 10,913,675 to Banker et. al., which also teaches various methods to achieve Zero Liquid Discharge (ZLD). Nested flowsheets include many unit operations which makes operation of such nested flowsheets complicated.

Treatment of the brine for contaminant removal (e.g., Se) is taught, for example by U.S. Pat. No. 10,723,645 to Riffe et. al., which describes that after Se is removed from the brine using zero valent iron or biological systems, the de-selenized brine (“second product water”) is blended with fresh water and then fed to the membrane treatment or the second product water is blended with permeate. A brine desaturation step for sulphate removal is also described.

Despite this large body of prior art, variations of the process flowsheet taught by Hill have not been utilized in the mining industry.

Improvements in the treatment of MCW to provide improved water recovery and high water purity are still desirable.

### SUMMARY

According to a first aspect, a process for treating MCW is provided. The process includes providing the MCW to a feed stream, adding acid to the feed stream to provide a reduced pH and alkalinity feed stream, subjecting the reduced pH and alkalinity feed stream to filtration and a membrane treatment to separate the reduced pH and alkalinity feed stream into permeate and brine, subjecting the brine to a high density sludge (HDS) process to produce a processed brine and residues; recycling a majority of the processed brine to the feed stream, separating a minor fraction of the processed brine to provide a bleed off of the processed brine prior to the recycling, and subjecting the bleed off of the processed brine to a subsequent treatment to remove at least some contaminants.

Generally, the process for treating MCW provides relatively high water recovery and produces relatively high purity water, residues, and a processed brine bleed off for further processing.

According to another aspect, the bleed of the processed brine and some or all the permeate is then subjected to subsequent treatment to remove and manage at least some of the soluble Se and NO₃ (and other soluble compounds) present in the highly concentrated processed brine bleed off.

Other aspects and features of the present application will become apparent to those ordinarily skilled in the art upon review of the following description of specific embodiments of the application in conjunction with the accompanying figures.

### BRIEF DESCRIPTION OF THE DRAWINGS

Embodiments of the present application will now be described, by way of example only, with reference to the attached figures, in which:

FIG. 1 is a simplified block flow diagram illustrating a process for treating MCW in accordance with an aspect of an embodiment;

FIG. 2 is a simplified block flow diagram illustrating an example of a process for treating MCW in accordance with an aspect of an embodiment;

FIG. 3 is a simplified block flow diagram illustrating another example of a process for treating MCW in accordance with an aspect of an embodiment;

FIG. 4 is a simplified block flow diagram illustrating a particular example of a process for treating processed brine in accordance with another aspect of an embodiment; and

FIG. 5 is a simplified block flow diagram illustrating another example of a process for treating processed brine in accordance with another aspect of an embodiment.

### DETAILED DESCRIPTION

For simplicity and clarity of illustration, reference numerals may be repeated among the figures to indicate corresponding or analogous elements. Numerous details are set forth to provide an understanding of the examples described herein. Examples may be practiced without these details. In other instances, well-known methods, procedures, and components are not described in detail to avoid obscuring the examples described. The description is not to be considered as limited to the scope of the examples described herein.

Generally, a process is provided for treating Mine Contact Water (MCW). The process includes providing the MCW to a feed stream, adding acid to the feed stream to provide a reduced pH and alkalinity feed stream, subjecting the reduced pH and alkalinity feed stream to filtration and membrane treatment to separate the reduced pH and alkalinity feed stream into permeate and brine, subjecting the brine to a high density sludge (HDS) process to produce a processed brine and primary residues, recycling a majority of the processed brine to the feed stream, separating a minor fraction of the processed brine to provide a bleed off of the processed brine prior to the recycling, and subjecting the bleed off of the processed brine and some or all the permeate to a subsequent treatment to remove at least some contaminants.

As utilized herein, MCW refers to water that has been impacted by a mining operation such as a coal, zinc, or copper mining and/or associated mineral processing operations. The MCW 102 referred to herein may be, for example, ground water from a mining operation, process water from a mining operation and/or from a mineral processing operation, run-off water after contact with rock dumps from mining of coal, or run-off water after contact with rock dumps from mining of zinc or copper.

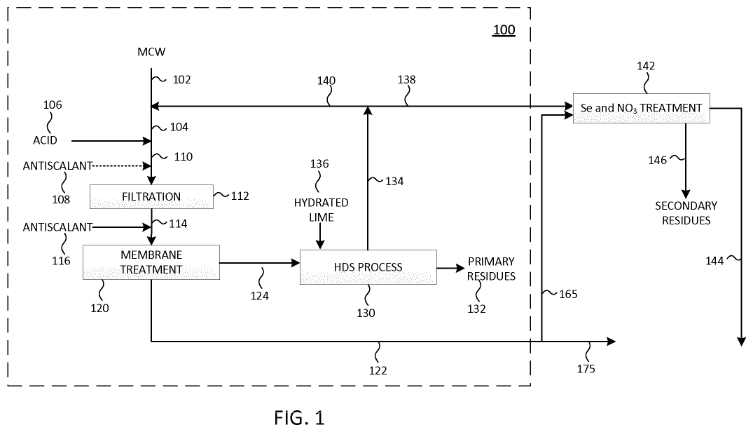

Referring to FIG. 1, a process for treating MCW 102 is shown. The MCW 102 may have a pH, for example, in the range of about 6.5 to about 8.5, and alkalinity (alkalinity expressed as mg/L CaCO₃) in the range of about 50 mg/L to about 600 mg/L. The MCW 102 also includes sulfate, for example, in the range of about 550 mg/L to about 2200 mg/L SO₄, a variable gypsum saturation (Gs), and Langelier Saturation Index (LSI) that may lead to scaling in membranes during membrane treatment. In addition, microbial presence in the MCW 102 may lead to biofouling in membranes.

The MCW 102 is provided to a feed stream and is blended with recycled processed brine stream 140, as referred to below to provide the combined stream 104. The pH of the feed stream 110 is adjusted by adding acid 106 to the combined stream 104. The pH of the combined stream 104 may be adjusted by adding sufficient acid 106 to reach a pH in the range of about 6 to about 8.5. The acid 106 may be, for example, sulphuric acid (H₂SO₄), hydrochloric acid (HCl), or nitric acid (HNO₃). The addition of the acid also lowers the alkalinity and provides a reduced pH feed stream 110. In addition to the acid 106, optionally, antiscalant 108 may be added to facilitate filtration 112.

The reduced pH feed stream 110 is subjected to filtration 112, which in this example is ultrafiltration, prior to membrane treatment 120. Residual solids present in the feed stream are partially dissolved with the acid 106 addition and further removed by the ultrafiltration 112.

Antiscalant 116 is added to facilitate operation of a subsequent membrane treatment 120. The antiscalant 116 may be phosphonate based and may be commercially available to facilitate operation of the membrane treatment 120 at target membrane water recoveries based on membrane treatment water recovery limits identified utilizing the Langelier (LSI) and gypsum saturation (Gs) indices.

Antiscalant 116 is added after filtration 112 and prior to the membrane treatment 120. The filtered and reduced pH feed stream 114, to which the antiscalant 116 is added, is then subjected to the membrane treatment 120 to separate the reduced pH feed stream into permeate 122 and brine 124. The membrane treatment 120 may include reverse osmosis (RO) membrane treatment or nanofiltration (NF) membrane treatment, or a combination of RO and NF membranes such that the filtered and reduced pH feed stream 114 is subjected to multiple membrane treatment stages.

The permeate 122 from the membrane treatment 120 may be discharged to the receiving environment or may be further treated. The permeate 122 may be further treated, for example, in instances in which the permeate includes significant quantities of dissolved carbon dioxide.

A fraction or all of the permeate 122, may be treated together with the processed brine stream bleed off stream 138 in a Se and NO₃ treatment process 142. The fraction or all of the permeate 122 is shown as stream 165. This treatment of the fraction or even all of the permeate shown as stream 165 is carried out, for example, when NO₃ removal from the permeate 165 is desired or in cases in which water for dilution is desirable to treat the processed brine bleed off 138 in the Se and NO₃ treatment process 142.

The brine 124 is subjected to a high density sludge (HDS) process 130 to produce residues 132 and processed brine 134. The HDS process 130 may include a series of reactors and a solid/liquid (S/L) separation. For example, the HDS process 130 may include up to 4 reactors in series for a total residence time of up to 4 hours, and solids content between about 30 g/L and about 120 g/L in each reactor. A S/L separation follows the reactors to separate out the residues 132 from the processed brine 134. The presence of total suspended solids (TSS) in the clarifier overflow of the S/L separation in the HDS process 130 is less than 100 mg/L.

Hydrated lime slurry 136 is added to the first reactor of the HDS process 130 such that the operational pH in the first reactor of the HDS process 130 is in the range of about 10.5 to about 11.4. The operational pH in the last reactor of the HDS process 130 is in the range of about 10.2 to about 11.1.

A flocculant is utilized in the solid/liquid separation in the HDS process 130 to facilitate separation of the residues 132 from the processed brine 134.

Residual antiscalant, which is phosphonate based, is largely removed in the first reactor of the HDS process 130. No external seed addition is utilized and clarifier underflow from the solid/liquid separation may be utilized as seed to achieve the solids content of between about 30 g/L and about 120 g/L in each reactor.

The residues 132 produced are primarily gypsum, calcite, and brucite. These residues 132 may be utilized in applications such as for fertilizers or may be landfilled. As gypsum (CaSO₄·2H₂O), calcite (CaCO₃), and brucite Mg(OH)₂ are removed from the brine in the HDS process 130, a fraction, for example, in the range of about 10% to about 50%, of selenium present in the MCW 102 is also removed in the residues 132.

The operational conditions in the HDS process 130 may be adjusted for removal of the residual antiscalant and gypsum from the brine 124.

Much of the selenium present in the MCW 102 is present as selenate (Se⁺⁶), which is the least bioavailable form of selenium. The oxidation state of the residual selenium present does not change in the process. Some of the Se⁺⁶ is sequestered in gypsum and in residues produced during the HDS process. Greater removal of Se⁺⁶ in gypsum occurs with higher concentrations of Se⁺⁶ in the brine 124. Thus, a significant fraction of Se⁺⁶ is removed and reports to the residues 132 to produce the processed brine 134 from the HDS process. Reduced selenium compounds that are present in the filtered and reduced pH feed stream 114 are concentrated in the brine 124 and significant quantities are removed in the HDS process 130. The residues 132 produced from the HDS process 130 are non-hazardous residues. Optionally, the residues 132 may be filter pressed.

A significant fraction of other trace components such as Ni, Co, U, Zn are also removed in the HDS process 130.

Most of the processed brine 134 (for example, more than 75%) is recycled back in the recycled processed brine stream 140, and blended with the mine contact water (MCW) 102 to produce the combined stream 104. A small fraction (for example, less than 25%) of the processed brine 134, however, is separated in a processed brine bleed off 138. The processed brine bleed off 138 is subsequently subjected to a Se and NO₃ treatment process 142 to remove at least some contaminants, including selenium and nitrate, providing treated water 144 and secondary residues 146. The selenium and nitrate removed may be utilized to produce, for example, fertilizers or explosives.

The overall water recovery rate, which is flow based, is the volume of permeate 122 from the membrane treatment 120 divided by the volume of MCW 102, multiplied by 100 to provide a percentage overall water recovery rate, WR, which may be 90% or greater. For example, the overall water recovery rate, WR, may be 98%. The total water in the processed brine bleed off 138 and to the residues 132 may be 10% or less.

The higher the recycle flow rate, i.e., the percentage of the processed brine 134 that is recycled back to the combined stream 104 in the recycled processed brine stream 140, the greater the expected overall water recovery. Remaining selenium (the majority of which, for example, greater than 99% is present as Se⁺⁶) in the processed brine 134 is concentrated and treated again, as the majority of the processed brine 134 is recycled to the front end of the process in the recycled processed brine stream 140.

The greater the flow rate or volume of processed brine 134 that is recycled back to the front end of the process, particularly relative to the processed brine bleed off 138, the higher the water recovery achieved.

By recycling most of the processed brine 134 to the front end of the process in the recycled processed brine stream 140, constituents of interest such as sulfate and selenate are concentrated by repeated membrane treatment 120 to achieve partial removal of these components in the HDS process 130. Greater than 75% of sulfate may be removed from the MCW 102 and alkalinity and trace components such as selenium, and nickel may be partially removed.

Treatment of the feed stream that includes MCW 102 blended with the recycled processed brine stream 140, is less likely to cause biofouling and scaling issues in the membrane treatment 120 than that likely to occur from treating MCW absent blending with processed brine, as a large fraction of the residual antiscalant and inorganic scaling compounds are removed in the HDS process 130 to produce the residues 132 including antiscalant and inorganic scaling compounds.

The resulting process provides reliable operability and process robustness as the process is capable of handling process upsets and treating influent waters with variable chemistry and at variable treatment rates.

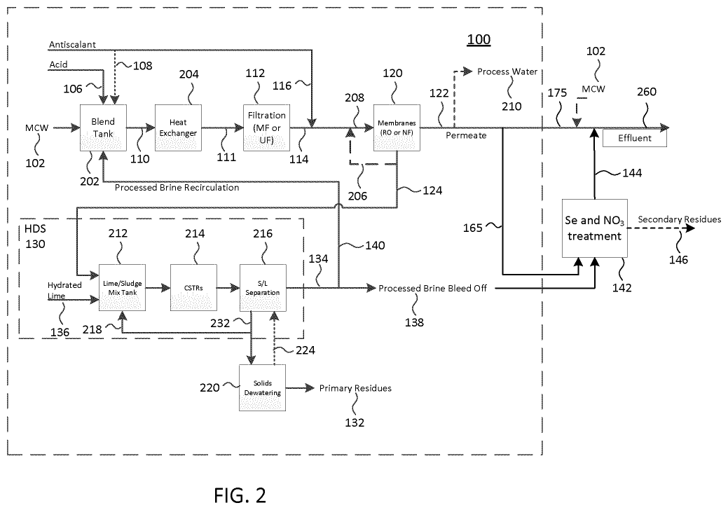

Reference is made to FIG. 2 to describe an example of a process for treating MCW 102. As shown in FIG. 2, the MCW 102 is blended with the recycled processed brine stream 140, in a blend tank 202. The pH of the feed stream is adjusted by adding acid 106. The pH of the resulting feed stream 110 may be adjusted by adding sufficient acid 106 to reach a pH in the range of about 6 to about 8.5 and an alkalinity between 50 mg/L and 450 mg/L. The addition of acid 106 also assists in reduction of TSS still present in in the recycled processed brine stream 140 that is recirculated to the blend tank 202, as some of the TSS in the recycled processed brine stream 140, are acid soluble (e.g., CaCO₃ and Mg(OH)₂).

The blend tank 202 in the present example is an agitated tank with a residence time of at least 15 min. For example, residence time in the blend tank 202 may be in the range of 15 minutes to 60 minutes.

The acid 106 may be, for example, sulphuric acid (H₂SO₄), hydrochloric acid (HCl), or nitric acid (HNO₃). The SO₄ added with H₂SO₄ may be removed in the HDS process 130. Cl and NO₃ are not removed in the HDS process 130.

The addition of the acid 106 provides a reduced pH and alkalinity feed stream 110 that is favourable for the process operation, and assists in dissolving some of the residual TSS from the recycled processed brine stream 140.

Acid addition 106 may be, for example, in the range of 20 to 160 mg/L H₂SO₄, or equivalent [H⁺] addition, if other acids are utilized. HCl or HNO₃ may also be successfully utilized. H₂SO₄ additions may be utilized because the SO₄ anion is effectively removed in the HDS process 130 whereas Cl and NO₃ anions are not, and Cl and NO₃ accumulate in the brine 134 when RO membranes are utilized in the membrane treatment 120.

Optionally, a heat exchanger 204 or multiple heat exchangers may be utilized to adjust the temperature of the feed stream 110 prior to filtration 112 to provide the reduced pH and alkalinity feed stream 111 with adjusted temperature.

In addition to acid addition, antiscalant 108 may be added prior to filtration 112. The antiscalant 108 may be phosphonate based and may be commercially available. The antiscalant 108 may be added to the blend tank 202 to facilitate operation of the heat exchanger 204 and filtration 112.

The reduced pH and alkalinity feed stream 111 is then subjected to filtration 112 utilizing one or both of microfiltration (MF) and ultrafiltration (UF) technologies, which may include one or more of backwashing (BW), chemically enhanced backwashing (CEB), and chemical in place (CIP) systems.

The filtration 112 is utilized to remove particles, large molecules, and suspended solids, and may result in silt density values (SDI) below 4 in the filtered and reduced pH feed stream 114.

The antiscalant 116 is then added to the filtered and reduced pH feed stream 114. The antiscalant addition facilitates operation of membrane treatment 120 at target membrane recovery (MR), which is the flow rate of permeate 122 divided by the flow rate of the filtered and reduced pH feed stream 114 fed to the membrane treatment 120. The target membrane treatment recovery may be based on membrane treatment recovery limits based on water chemistry and operational conditions. The antiscalant dosage may be obtained using commercially available software. Even with addition of antiscalant and acid, membrane recovery is eventually limited by upper limits in the LSI and Gs of the brine 124.

LSI values below 2 and Gs values below 6 in the brine 124 are desirable for stable operation of the membrane treatment 120.

The filtered and reduced pH feed stream 114, with additional antiscalant 116, and with a fraction 206 of produced brine 124 that is recycled back from the membrane treatment 120 is provided as a blend 208 that is fed to the membrane treatment 120.

Alternatively, additional antiscalant 116 is added to the filtered and reduced pH feed stream 114 to provide a blend that is directly fed to the membrane treatment 120. In this alternative, the membrane treatment 120 operates in multiple membrane stages and passes, and the fraction 206 of the produced brine 124 is not recycled to the feed of the membrane treatment.

The stream 208, including the filtered and reduced pH feed stream 114 and the fraction 206 of the produced brine 124 is then subjected to membrane treatment 120 to produce permeate 122 and brine 124.

Alternatively, the membrane treatment 120 may include various stages and phases of treatment using reverse osmosis (RO) or nanofiltration (NF) membranes or both in multiple configurations, which may include multiple stages and passes of membrane treatment, which may not require fractional brine recirculation 206.

Membrane recovery, MR, may be adjusted during the process depending on several factors, which may include variations in chemistry of the MCW, and chemistry and temperature of the stream 208 fed to the membrane treatment 120, membrane type, and membrane configuration utilized. Commercially available software (e.g., WAVE from Dupont) may be utilized to identify membrane operational conditions, stages, and passes utilized based on various water chemistry and water temperatures to be treated.

Other suitable membrane systems such as electrodialysis reversal (EDR) may also be utilized in the membrane treatment 120.

As indicated above, a fraction 206 of the brine 124 may be recycled to produce the stream 208. A fraction 210 of the produced permeate 122 may be utilized for backwashing the filtration 112, periodically flushing the membranes in the membrane treatment 120, and for reagent preparation. The filtration 112 may also be backwashed with the filtered and reduced pH feed stream 114.

The remaining permeate 122 may be discharged to the receiving environment or may be further treated. For example, the remaining permeate 122 may be further treated by adjusting the hardness, adjusting the pH, removing dissolved gases, or any combination thereof. For example, the permeate 122 may be further treated in instances in which the permeate has low pH (<7) and has significant quantities of dissolved carbon dioxide that could be harmful to aquatic organisms.

As permeate 122 alone may be toxic to aquatic organisms, the permeate 122 may be blended with MCW 102 or with processed brine bleed off 138, or both, to provide the effluent 260 prior to discharge to the receiving environment. Alternatively, the permeate 122 may be blended with chemicals that remineralize the water to provide the effluent 260 prior to discharge to the receiving environment. A fraction or all the permeate may also be further treated as stream 165 together with the processed brine bleed off 138 in a Se and NO₃ treatment process 142.

The brine 124 from the membrane treatment 120 is then subjected to a high density sludge (HDS) process 130, which in the present example, includes a lime/sludge mix tank 212, continuous stirred-tank reactors (CSTRs) 214, and a S/L separator 216. The HDS process 130 produces a sludge 232 and processed brine 134.

The HDS process 130 may include a series of reactors. Hydrated lime 136 may be utilized to increase the pH of the brine (to pH values as high as 11.4 in the first reactor), and to precipitate gypsum, calcite, brucite, and trace compounds (e.g., hydroxides of Ni, Co, Zn). For example, the HDS process 130 may include up to 4 continuous stirred-tank reactors (CSTRs) 214 in series for a total residence time of about 2 hours to about 4 hours, with solids content between about 30 g/L and about 120 g/L in each reactor. High solids content in these reactors facilitates removal of the antiscalant and removal of contaminants, as well as the removal of gypsum and calcite supersaturation from the brine.

The S/L separation 216 may utilize a thickener/clarifier (referred to as the clarifier), utilized to separate most of the solids, referred to as residues 232 which are in the form of a sludge, from the processed brine 134. The processed brine 134, which is the clarifier overflow, may have a pH ranging between 10.2 and 11.1, and a TSS below 100 mg/L. For example, the TSS may be below 30 mg/L. A flocculant may be utilized in the S/L separation 216 to facilitate separation of the solids, and to produce the processed brine 134 with less than 100 mg/L, preferably below 30 mg/L. Reduction of TSS in S/L separation 216 is desired to lower the demand for acid addition in 106, to reduce the amount of gypsum solids recycled, and reduce the amount of solids removed in Filtration 112.

A fraction of, for example, more than 80% of the sludge 232 produced in the S/L separation 216, which is also referred to as clarifier underflow, is recycled as stream 218 to the lime/sludge mix tank 212, and another fraction of, for example, less than 20% of the sludge 232 produced is bled, then subjected to dewatering and filtering at 220, to produce the primary residues 132, which include gypsum, calcite and brucite, with some contaminants. Recovered water 224 from the dewatering and filtering 220 is recycled to the S/L separation 216, or alternatively to the final one of the CSTRs 214.

The hydrated lime 136 together with the fraction of the clarifier underflow sludge, referred to as stream 218, is added to the lime/sludge mix tank 212 before the first CSTR 214, such that operational pH in the first CSTR 214 is in the range of about 10.5 to about 11.4. The operational pH in the last CSTR 214 may be in the range of about 10.2 to about 11.1. The higher the operational pH in the last CSTR 214, the higher the fraction of Mg removed from the brine 124.

Residual antiscalant, which may be phosphonate-based, is largely removed in the HDS process 130, as indicated by phosphorus, P, chemical assays in tests carried out.

No additional external seed addition is utilized in the HDS process 130, with clarifier underflow sludge from the solid/liquid separation and hydrated lime having been utilized as seed to achieve a solids content between about 30 g/L and about 120 g/L in each of the CSTRs utilized in the HDS process, a solids content range between 50 and 60 g/L is considered to provide good results.

As indicated, the primary residues 132 are primarily gypsum, calcite, and brucite as well as contaminants that are partially removed (e.g., Se, Ni, U) in the HDS process 130. These primary residues 132 are non-hazardous and may be useful in various applications or may be landfilled.

Operational conditions in the HDS process 130 may be further adjusted for effective removal of the residual antiscalant and gypsum and calcite supersaturation from the brine 124, for example by adjusting the residence time or solids content in the CSTRs 214.

Most of the selenium present in the MCW 102 is present as selenate (SeO₄⁻² referred as Se⁺⁶), which is the least bioavailable form of selenium. Low levels of reduced selenium compounds (e.g., Se⁺⁴) that may be present in the MCW 102, also report to the brine 124, and Se⁺⁴ is largely (>99%) removed in the HDS process 130. The oxidation state of selenium does not change in the process. Some of the Se⁺⁶ present in the brine is sequestered in the primary residues 132 produced during the HDS process 130. Increased removal of Se⁺⁶ in residues is expected as more SO₄ and total dissolved solids are removed and as water recovery increases.

While large fractions of the gypsum (CaSO₄·2H₂O), calcite (CaCO₃), and brucite Mg(OH)₂ are removed from the brine in the HDS process 130, only a fraction of Se, in the range of about 10% to about 30% of the Se originally present in the MCW 102, is removed and is present in the primary residues 132.

This approximate Se removal is based on [Se] in MCW 102, on volume flow of MCW 102 treated, and on [Se] in the residues produced in tests carried out after reaching steady state conditions. The calculation does not account for accumulation of Se compounds in processed brine 134.

A fraction of other trace components such as Ni, Co, U, Zn, and total organic carbon (TOC) are also removed in the HDS process 130, eventually reporting to the primary residues 132.

The primary residues 132 are considered to be non-hazardous in that the primary residues 132 pass the Toxicity Characteristic Leaching Procedure (TCLP).

During operation, a majority, for example >75%, of the processed brine 134 is recirculated back as the recycled processed brine stream 140 to the blend tank 202. A small fraction of the processed brine 134, however, is separated in the processed brine bleed off 138.

The recycled processed brine stream 140 acts as a circulating load, in which soluble compounds accumulate, until steady state concentrations are achieved in the processed brine that is recirculated during stable operational conditions.

When RO membranes are utilized, and H₂SO₄ is utilized as added acid 106, steady state is indicated when [Cl] and [NO₃] in the processed brine 138 no longer change significantly with treatment time.

The processed brine bleed off 138, containing most of the Se and NO₃ originally present in MCW when RO membranes are utilized in the membrane treatment 120, is subsequently subjected to the Se and NO₃ treatment process 142 to remove at least some of the Se and NO₃, providing treated water 144 and secondary residues 146.

When NF membranes are utilized in the membrane treatment 120, the permeate 122 may still contain a significant fraction, for example, of the N—NO₃ and of the alkalinity originally present in MCW 102, but Se and SO₄ may still be largely rejected, for example, >98% rejection, to the processed brine 134. Thus, a fraction or all the permeate may still be subjected to the subsequent Se and NO₃ treatment process 142 to remove contaminants, and/or to provide carrier water for assisting in the treatment of the processed brine bleed off 138.

Thus, NF membranes may be utilized in the membrane treatment 120, particularly when significant alkalinity and significant N—NO₃ removal from MCW 102 is not sought. A subsequent Se and NO₃ treatment process is utilized, however.

The subsequent Se and NO₃ treatment process 142 may be utilized for removal of Se and NO₃ from water or may be a process based on physical-chemical treatment that is utilized to separate and/or remove key compounds in the processed brine bleed off 138.

The processed brine bleed off 138 may be subjected to the Se and NO₃ treatment process to provide chemicals that may be subsequently utilized. For example, the Se and NO₃ treatment process may be utilized to produce chemicals that may be utilized in the manufacture of fertilizers or explosives or to produce stable secondary residues from the processed brine bleed off 138.

The Se and NO₃ treatment process may be a biological treatment.

Alternatively, if no subsequent treatment of the processed brine bleed off 138 or of the permeate 122 is desired, the processed brine bleed off 138 may be blended with the permeate 122 from the membrane treatment 120 and, optionally blended with MCW 102 followed by discharging to the receiving environment as stream 260.

Optionally, additional heat exchangers may be utilized to adjust the temperature or recover heat from the permeate 122 and the processed brine bleed off 138 prior to discharge to the receiving environment.

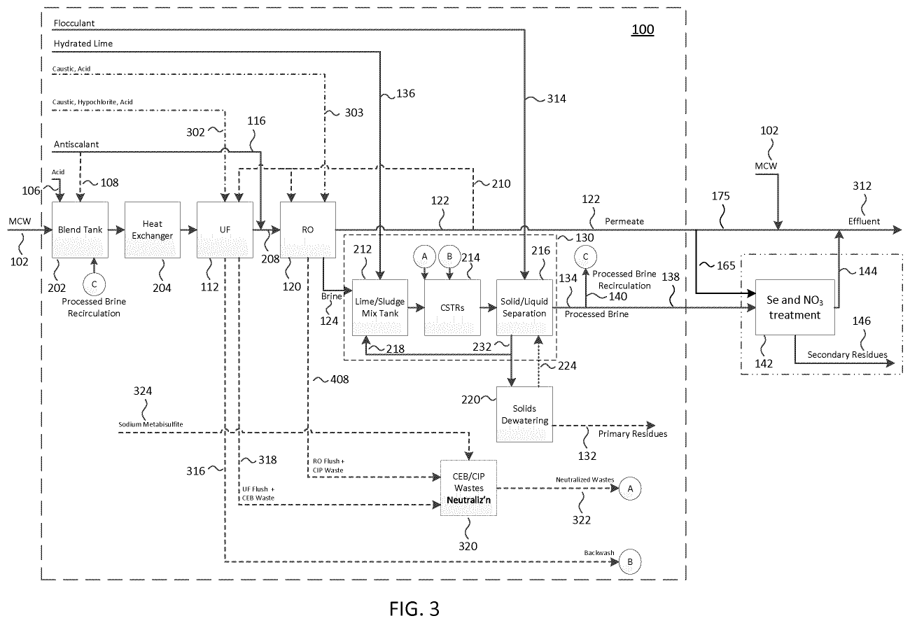

Reference is made to FIG. 3 to describe another example of a process for treating MCW. Many of the elements, including treatments, subprocesses, and streams are similar to those described above with reference to FIG. 1 and FIG. 2. For consistency and clarity, the same reference numerals are utilized to denote the same or similar elements in FIG. 3. Many of the elements are not described again in detail.

In the present example, the filtration 112 is ultrafiltration. In addition, caustic, hypochlorite, and acid addition 302 are utilized in the ultrafiltration for periodic chemical cleaning of the membranes, which may include one or both of chemical enhanced backwashing (CEB) and chemical-in-place (CIP) cleaning.

The membrane treatment 120 is a RO membrane treatment. A fraction 210 of the permeate 122 from the membrane treatment 120 is utilized for backwashing the filtration 112, and for periodically flushing the membranes in the membrane treatment 120. A fraction or all the produced permeate, shown as stream 165 may also be treated in the Se and NO₃ treatment process 142. Antiscalant 116 is also added to facilitate operation of the membrane treatment 120. Caustic and acid-containing chemicals 303 are utilized in the RO membrane treatment 120 for periodic cleaning of the membranes, via CIP procedures.

The remaining permeate fraction 175 is combined with MCW 102 and with treated water 144 from the subsequent Se and NO₃ treatment process 142 that is utilized for removal of Se and NO₃ from water, resulting in effluent 312 that is not toxic to the receiving environment. Secondary residues 146 are also produced from the Se and NO₃ treatment process where selenium and nitrate are removed and secondary residues 146 are produced.

The HDS process 130 includes the lime/sludge mix tank 212, continuous stirred-tank reactors (CSTRs) 214, and a S/L separator 216. The HDS process 130 produces the residues 132 and processed brine 134. In the present example, a flocculant 314 is utilized in the S/L separation 216 to facilitate separation of the solids, and to produce the processed brine 134 with less than 50 mg/L TSS.

As indicated above, a fraction 210 of the permeate 122 from the membrane treatment 120 is utilized for backwashing the filtration 112, for periodically flushing the membranes in the membrane treatment 120 and for reagent preparation. The fraction 210 of the permeate 122 is utilized as the permeate 122 has low alkalinity and TDS and is an effective stream for backwashing. Alternatively, filtrate from the filtration 112 may be utilized for backwashing the ultrafiltration (UF) membranes utilized in the filtration 112.

A slurry stream 316 is obtained after backwashing the membranes utilized in the filtration 112. This slurry stream 316 may be added to one of the CSTRs 214. Alternatively, slurry stream 316 may be fed into the S/L separation 216.

Waste streams 318 and 408 that are produced from chemical enhanced backwashing (CEB) and clean in place (CIP) procedures, that are utilized for maintenance of the membranes used in filtration 112 and membrane treatment 120 are neutralized at 320 and Na₂S₂O₅(sodium metabisulfite) 324 may be added, to remove any residual chlorine still present in stream 320 (e.g., when hypochlorite is used in CEB or CIP procedures). The neutralized wastes 322 that are produced may be fed to one of the CSTRs 214. Acidic waste (pH<5) from acidic CEB and CIP procedures (those not using hypochlorite) may also be recycled to the blend tank 202. In addition, membrane flushes may be recycled to blend tank 202.

Overall water recovery (WR) in a full scale plant, may be 90% or greater. WR of 98% or higher may be achieved. Correspondingly total water flow in the processed brine bleed off 138 may be 10% or less of the flow of MCW 102.

The permeate 122 may be discharged to the receiving environment after adjusting one or more of hardness, pH, and dissolved [CO₂] or after blending with MCW 102, to produce effluent that is not toxic to the receiving environment.

The higher the percentage of processed brine 134 that is recirculated back to blend tank 202 as the recycled processed brine stream 140, the greater the expected WR and the higher the [Se] and [N—NO₃] in the processed brine bleed off 138, while the [SO₄] in the processed brine bleed off 138 may be kept between 1100 mg/L and 2000 mg/L even at WR greater than or equal to 90%.

The higher the percent of recycled processed brine stream 140 in relation to total flow of brine produced 134, the higher the WR possible. Recycling more than 75% of processed brine 134 as the recycled processed brine stream 140 provides a high WR. At any given point in time, recycle ratios (ratio of flow rate of the recycled processed brine stream 140 divided by flow rate of total processed brine 134 times 100) may vary between 1 and 100%, however.

By recycling a high-volume percent of 75% or greater of the processed brine 134 to the front end of the process via the recycled processed brine stream 140, soluble contaminants such as selenate and nitrate are concentrated in the brine by repeated membrane treatment 120. In addition, greater than 90% of the sulphate may be removed from MCW 102 and alkalinity and some trace components such as Se, Ni, and U are also partially removed in the HDS process 130. Nitrate and chloride are not significantly removed in the HDS process.

The recycled processed brine stream 140 also acts as an accumulator and includes a significant quantity of constituents, for example, SO₄, Se, NO₃, Ca, Na, and others, originally present in the MCW 102. By continuously bleeding a small fraction of the processed brine 134 as the processed brine bleed off 138, steady state concentrations of these compounds are achieved.

Still a large fraction of Se and NO₃ originally present in the MCW 102 may remain in the processed brine bleed off 138, which is further treated.

The treatment of the blended stream 208 is less likely to cause biofouling and scaling issues in the membrane treatment 120 by comparison to treating only MCW 102. With the blending of the recycled processed brine stream 140 with MCW 102, the LSI of stream 208 is also lowered, facilitating achievement of higher MR values in the membrane treatment 120.

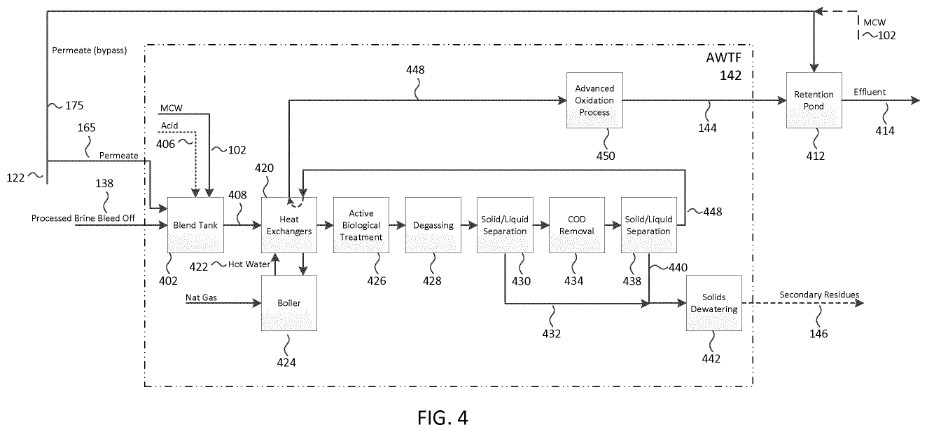

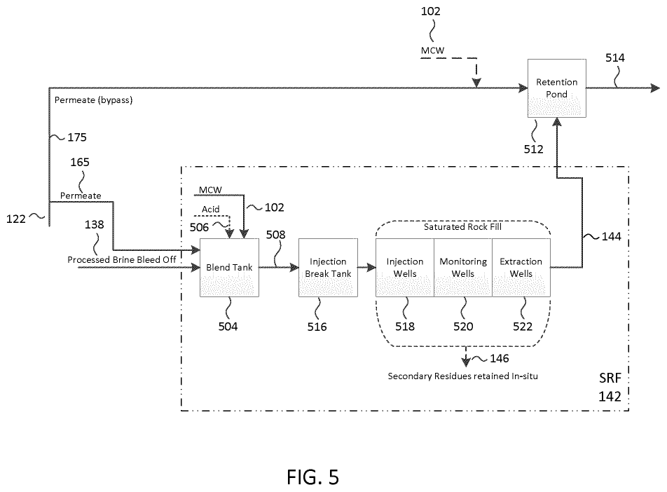

FIG. 4 and FIG. 5 illustrate two examples of processes for treating processed brine in the Se and NO₃ treatment process 142. In the example shown in FIG. 4, the Se and NO₃ treatment process is an active water treatment facility (AWTF).

Referring first to FIG. 4, the membrane treatment and HDS process such as that shown in FIG. 3, using either NF or RO membranes in the membrane treatment 120, is utilized to produce the permeate 122 and the processed brine bleed off 138.

The processed brine bleed off 138 is treated with MCW 102 and a fraction 165 of the permeate 122 in the AWTF as the Se and NO₃ treatment process 142. The processed brine bleed off 138 together with MCW 102, and the fraction 165 of permeate 122 and acid is blended in the blend tank 402.

A fraction 165 of the permeate 122 and acid 406 may be added to the blend tank 402 as referred to above or may be combined with the processed brine bleed off 138 prior to transferring the processed brine bleed off 138 to a biological treatment plant. The fraction 165 of the permeate 122 or all of the permeate 122 may be subjected to nitrate removal in the AWTF, (for example, when NF membranes are utilized in membrane treatment 120). Also permeate 165 may be added to dilute the processed brine bleed off 138 to reduce scaling of tanks and piping utilized to store and transfer the processed brine bleed off 138, and also to assist in lowering the alkalinity of the stream 408. Acid 406 may also be utilized to manage alkalinity in the Active Water Treatment facility (AWTF).

A fraction of the permeate 122, shown as stream 165 is treated in the AWTF. The remaining permeate fraction 175 (from 0 to 100%) of the permeate 122 may by-pass treatment and may be discharged to a retention pond 412 and to effluent 414. MCW 102 may be added to the remaining permeate fraction 175 prior to discharge to the retention pond 412, to increase the pH of the remaining permeate fraction 175 prior to blending in the retention pond with treated water 144 from the AWTF.

The AWTF includes many unit operations and many variations of operations illustrated in FIG. 4 may be utilized to treat of the processed brine bleed off 138, the MCW 102, and fraction 165 of the permeate.

The AWTF is utilized to treat a certain maximum hydraulic flow rate, and to remove Se and NO₃ to produce a final effluent 144 with <30 μg/L Se and <3 mg/L N—NO₃ and <10 ppm TSS.

As shown in FIG. 4, the blended stream 408 is first heated to a temperature of about 15° C. to about 30° C. in a heat exchanger 420 to promote denitrification and selenium removal reaction rates in the subsequent treatment. The heat exchanger 420 may utilize hot water 422 that is heated in a boiler 424 and fed to the heat exchanger 420 for heat exchange with the stream 408 to heat the stream 408 to temperature.

The heated stream is then subjected to an active biological treatment (ABT) 426 where Se and NO₃ are removed. The ABT may include Fluidized Bed Reactors (FBR), up-flow and down-flow Packed Bed reactors (PBR), or Moving Bed Bioreactors (MBBR), or combinations thereof. For example, the ABT 426 may be FBRs with addition of electron donors such as, methanol, and micronutrients such as phosphorus.

The ABT 426 produces an effluent including biomass. Removal of the biomass is facilitated by degassing 428 of the ABT effluent, followed by S/L separation 430. The S/L separation may be carried out utilizing a ballasted sand clarifier and thickeners.

Residual chemical oxygen demand (COD) still present in the liquid after S/L separation, is removed, for example utilizing a moving bed bioreactor (MBBR) 434. A further S/L separation 438 is carried utilizing, for example, continuously backwash sand filters (CBSF).

Slurry 432 from the S/L separation 430 and slurry 440 from the S/L separation 438 is then subjected to solids dewatering 442 by a filtering process and the solids separated by the solids dewatering 442 may be pressed to produce non-hazardous secondary residues 146 that passes TCLP testing and may be disposed off-site.

The secondary residues 146 may include residual biomass, trace metals, and Fe(OH)₃ solids from an addition of FeCl₃ coagulant in the S/L separation 430 and the S/L separation 438. A precoat of diatomaceous earth may be utilized during the dewatering process, to facilitate the dewatering performance.

The secondary residues 146 may still include about 40% solids and 60% water with the remaining water bound, rather than free draining. The [Se] in the residues 444 may be low, for example, about 1200 mg/kg.

The treated liquid 448 from the S/L separation 438 may be sent to the heat exchanger 420 to recover heat, thus lowering the temperature prior to treatment in an advanced oxidation process (AOP) 450, and then to the retention pond 412 where the AOP treated stream is deposited with the remaining permeate fraction 175 prior to final water discharge 414.

The ABT 426 may produce a small amount of reduced selenium compounds that may have high bioavailability. The Advanced Oxidation Process (AOP) 450 may be a process such as that described in U.S. Pat. No. 10,947,137 and is utilized to convert reduced selenium compounds to selenate, which is the least bioavailable soluble selenium compound.

Thus, the Se and NO₃ treatment process 142 for treatment of the processed brine bleed off 138 and a fraction or all the permeate shown as stream 165 in FIG. 1 and in FIG. 3 may be an ABT-based process (e.g., an AWTF) for Se and NO₃ removal as shown in FIG. 4.

FIG. 5 shows another example of a process including Se and NO₃ treatment process. In the example shown in FIG. 5, the Se and NO₃ treatment process is a Saturated Rock Fill (SRF). The membrane treatment and HDS process such as that shown in FIG. 2 and FIG. 3 (using either NF or RO membranes in the membrane treatment 120) is utilized to produce the permeate 122 and the processed brine bleed off 138, which is then treated using the SRF-based treatment shown in FIG. 5.

The processed brine bleed off 138 together with MCW 102 and acid 506 are fed to a blend tank 504. In addition, the fraction 165 of the permeate 122 or all of the permeate 122 may be added to the blend tank 504. The fraction 165 or all of the permeate 122 may be also subjected to treatment in the SRF, for example, when NF membranes are utilized in membrane treatment 120.

An SRF used as the Se and NO₃ treatment process 142 may be utilized to treat larger volumes of water and to remove more Se and NO₃ than an ABT-based process such as that shown FIG. 4.

Depending on the hydraulic and loading capacity of the SRF process and on the hydraulic capacity of the process shown in FIG. 5, for example, in the absence of addition of the fraction 165 of the permeate 122, the flow ratio of MCW 102 to the processed brine bleed off 138 treated in the SRF may be as low as 5 or as high as 500. The processed brine bleed off 138 may also be stored and later treated.

The fraction 165 of the permeate 122 and acid 502 may be added to blend tank 504 as shown and referred to above or may be combined with processed brine 138 in another manner before SRF treatment. The permeate addition may also be utilized to dilute the processed brine 138 to reduce scaling of tanks and piping utilized to store and send brine to the SRF and to assist in lowering the alkalinity and pH of the combined stream 508 and assisting in operation of the SRF.

The remaining fraction 175 of (between 0 and 100%) of the permeate 122 may bypass the SRF treatment and may be blended with MCW 102 and then blended with effluent 144, for storage in a retention pond 512 and final discharge 514. The fraction 165 of the permeate may be fed to the blend tank 504 as referred to above.

The combined stream 508 may be fed to an injection break tank 516 utilized to feed the injection wells using flow control valves. The stream is then fed to the SRF treatment, which includes a generally linear well field with injection wells 518 and several rows of extraction wells 522 positioned to create separate dominantly linear flow fields. Rows of monitoring wells 520 are positioned within the flow field for monitoring system performance and to provide data for operational decisions.

Reagents including carbon as an electron donor, for example, methanol, and nutrients to support microbiological productivity, for example, phosphorus which may be in the form of phosphoric acid and/or yeast extract, are added to the influent water in the injection wells 518 in quantities sufficient to facilitate biological removal of NO₃ and Se. Optionally, a tracer may be added to the combined stream 508 to support operational decisions and monitor system performance.

Secondary residues 146 produced during Se and NO₃ removal are retained within the SRF.

The SRF process is utilized to treat up to a maximum hydraulic flow rate of water, and to remove Se and NO₃ to produce an effluent 144 with <30 μg/L Se and <1 mg/L N—NO₃ and <10 ppm TSS.

By adding the concentrated processed brine bleed off 138 to the blend tank 504, the [Se] and [N—NO₃] in the stream 508 is increased over the [Se] and [NO₃] present in MCW 102. The blending in the blend tank 504, that also includes the capability of blending with the fraction 506 of the permeate 122, however, is utilized to maintain the stream 508 within the overall chemical range and hydraulic limits of the SRF, while still meeting final plant effluent compositional targets.

Optionally, an AOP process may be implemented to treat the effluent 144 from the SRF in the event that reduced selenium compounds are produced in the SRF and present in the effluent 144.

In summary, the processes illustrated in FIG. 1 through FIG. 3, provide reliable operability and process robustness, as demonstrated by months of operation of a pilot plant, utilizing MCW. A relatively small volume of processed brine bleed off 138 may be further treated for Se and NO₃ removal, for example, to recover chemical compounds useful to society. Produced permeate 122, may be blended with MCW and discharged to the receiving environment. Optionally produced permeate may be blended with chemicals to remineralize the permeate prior to discharging the permeate to the receiving environment.

Thus, only a fraction of all the produced processed brine 134 leaves the processes of FIG. 1 through FIG. 3 as processed brine bleed off 138, in flows much smaller than those of the produced brine 134, making management of the processed brine bleed off 138 for removal of residual components still present in the processed brine 134 more efficient, as these components are more concentrated in the processed brine bleed off 138 than in the MCW.

### EXAMPLES

The following examples are submitted to illustrate embodiments of the present invention. These examples are intended to be illustrative only and not intended to limit the scope of the present invention. Examples 1 to 3 show experimental results from pilot plant testing of total dissolved solids (TDS) removal block 100. Details of MCW, blended feed, brine, processed brine, and permeate chemistry are provided in Table 1 and details of the pilot plant operation and results are provided in Tables 2 to 7. MCW utilized in the following examples is from a coal mining operation. MCW from other mining operations may also be treated utilizing the present process.

In all examples, the pilot plant operated under stable operational conditions during and before, each Demonstration period.

Table 1 shows MCW chemistry of Examples 1 to 3, referred to as Ex.1 to Ex. 3 in Table 1, treated in a pilot plant in accordance with the present method.

During the Demonstration periods in each example, chemistry of the processed brine 134 is similar to that of the processed brine bleed off 138 and the recycled processed brine stream 140 and considered to be the same in this description of the pilot plant results.

TABLE 1
Examples of Water Chemistry Treated and Produced (average
assays values obtained in each Demonstration period)

| | Unit | Ex. 1 | Ex. 2 | Ex. 3 | Ex. 1 | Ex. 2 | Ex. 3 | Ex. 1 | Ex. 2 | Ex. 3 |
|---|---|---|---|---|---|---|---|---|---|---|
| Stream | | MCW 102 | | | Blended Feed 114 | | | Brine 124 | | |
| Alkalinity | mg/L | 345 | 382 | 538 | 254 | 215 | 280 | 532 | 709 | 798 |
| Conductivity | μS/cm | 1797 | 2170 | 3588 | 2017 | 2770 | 4803 | 5197 | 7515 | 11100 |
| pH | — | 7.9 | 8.0 | 7.9 | 7.4 | 6.9 | 7.4 | 7.6 | 7.9 | 7.3 |
| TDS | mg/L | 1630 | 1833 | 3756 | 1630 | 2420 | 3756 | 6075 | 8075 | 12250 |
| TSS | mg/L | <3 | <3 | <3 | <3 | <3 | <3 | 4.0 | 2.0 | 2.0 |
| [Cl] | mg/L | 4.7 | 5.1 | 13 | 4.7 | 33 | 73 | 4.7 | 116 | 194 |
| [N—NO₃] | mg/L | 11 | 14 | 46 | 10 | 70 | 248 | 9.1 | 209 | 625 |
| [SO₄] | mg/L | 758 | 1025 | 1894 | 1016 | 1290 | 1938 | 3508 | 4330 | 5083 |
| [TOC] | mg/L | 1.1 | 1.4 | 1.2 | 2.6 | 3.3 | 3.7 | NA | 9.5 | 9.0 |
| [Ca], total | mg/L | 212 | 274 | 408 | 325 | 447 | 713 | 1052 | 1500 | 1960 |
| [Co], total | μg/L | 0.1 | 0.2 | 0.2 | 0.2 | 0.2 | 0.4 | 0.9 | 1.0 | 1.0 |
| [Mg], total | mg/L | 141 | 192 | 365 | 119 | 150 | 275 | 435 | 512 | 791 |
| [Ni], total | μg/L | 37 | 40 | 32 | 30 | 30 | 22 | 106 | 102 | 53 |
| [P], total | mg/L | 0.05 | 0.08 | 0.10 | 0.01 | 0.07 | 0.07 | 0.53 | 0.45 | 0.49 |
| [K], total | mg/L | 2.4 | 2.6 | 6.3 | 3.0 | 9.1 | 20 | 4.8 | 27 | 49 |
| [Se], total | μg/L | 293 | 394 | 395 | 1011 | 1555 | 1665 | 3763 | 4830 | 4280 |
| [Na], total | mg/L | 2.0 | 2.6 | 16 | 2.4 | 14 | 68 | 4.0 | 43 | 191 |
| [U], total | μg/L | 11 | 18 | 29 | 8.8 | 13 | 19 | 32 | 47 | 53 |
| [Zn], total | μg/L | 76 | 70 | 61 | 63 | 51 | 42 | 226 | 166 | 111 |
| Temperature | ° C. | 5 | 5 | 5 | 5 | 5 | 5 | 7 | 12 | 12 |
| LSI | — | 0.8 | 1.0 | 1.2 | 0.3 | −0.1 | 0.7 | 1.3 | 2.0 | 1.5 |
| Gs | — | 0.3 | 0.4 | 0.7 | 0.5 | 0.7 | 1.1 | 2.1 | 2.8 | 3.4 |

| | Unit | Ex. 1 | Ex. 2 | Ex. 3 | Ex. 1 | Ex. 2 | Ex. 3 |
|---|---|---|---|---|---|---|---|
| Stream | | Processed Brine 134 | | | Permeate 122 | | |
| Alkalinity | mg/L | 69 | 75 | 80 | 168 | 6.0 | 5.0 |
| Conductivity | μS/cm | 2773 | 4460 | 7190 | 423 | 15 | 44 |
| pH | — | 10.6 | 10.7 | 10.5 | 8.1 | 5.7 | 5.8 |
| TDS | mg/L | 2900 | 4295 | 6718 | 293 | 14 | 45 |
| TSS | mg/L | 13 | 16 | 24 | <3 | <3 | <3 |
| [Cl] | mg/L | 8.3 | 121 | 194 | 3.1 | 0.5 | 0.6 |
| [N—NO₃] | mg/L | 10 | 244 | 650 | 10 | 0.8 | 3.9 |
| [SO₄] | mg/L | 1920 | 1850 | 1625 | 6.2 | 0.9 | 0.7 |
| [TOC] | mg/L | 7.0 | 9.7 | 8.2 | NA | 0.5 | 0.5 |
| [Ca], total | mg/L | 717 | 999 | 1385 | 67 | 0.7 | 0.9 |
| [Co], total | μg/L | 0.5 | 0.5 | 0.5 | 0.1 | 0.1 | 0.1 |
| [Mg], total | mg/L | 24 | 48 | 80 | 8.7 | 0.2 | 0.3 |
| [Ni], total | μg/L | 2.5 | 2.0 | 2.5 | 2.8 | 0.5 | 0.5 |
| [P], total | mg/L | 0.02 | 0.02 | 0.02 | 0.002 | 0.002 | 0.003 |
| [K], total | mg/L | 5.1 | 31 | 49 | 2.3 | 1.0 | 3.1 |
| [Se], total | μg/L | 3567 | 5195 | 4282 | 6.3 | 1.4 | 0.6 |
| [Na], total | mg/L | 4.1 | 52 | 184 | 2.0 | 0.6 | 4.4 |
| [U], total | μg/L | 0.2 | 0.1 | 0.2 | 0.04 | 0.01 | 0.01 |
| [Zn], total | μg/L | 15 | 15 | 15 | 3.7 | 3.0 | 3.0 |
| Temperature | ° C. | 7 | 12 | 12 | 7 | 12 | 12 |
| LSI | — | 3.3 | 3.7 | 3.6 | 0.3 | −5.3 | −5.3 |
| Gs | — | 1.3 | 1.4 | 1.4 | 0 | 0 | 0 |

Pilot tests were carried out using various MCW from a coal mining operation, with MCW 102 average water chemistries shown in Table 1. The pilot plant to test the process 100 illustrated in FIG. 1 through FIG. 3 was set up to treat between 7 and 12 m³/d of MCW. The pilot plant operated for more than 4 months, treating close to 1450 m³ of MCW in that period. Several tests were carried out.

In general, MCW 102 from Coal Mining operations has a pH in the range of about 6.5 to about 8.5, and an alkalinity (alkalinity as CaCO₃) in the range of about 50 mg/L to about 600 mg/L.

In general, the MCW 102 includes sulphate concentrations, [SO₄] in the range of about 550 mg/L to about 2200 mg/L, nitrate as nitrogen [N—NO₃] concentrations in the range between 1 and 200 mg/L, and selenium concentrations, [Se] between 10 and 1000 μg/L. Fe, Al, Mn concentrations in MCW are usually below 0.05 mg/L in MCW 102.

In general, LSI values in MCW 102 are in the range of 0.2 to 1.4, and have Gs values in the 0.1 to 1 range. In some cases (e.g., when treating process water from mineral processing operations) MCW may have Gs values in excess of 1. Thus, in general, MCW is normally supersaturated in calcite and undersaturated with gypsum.

The temperature of the MCW 102 may fluctuate seasonally between 1 and 15° C. Total organic carbon values in MCW range between 0.5 and 3 mg/L.

In the pilot plant, the water temperature of the feed stream 110 was adjusted to about 4° C. to about 6° C. using a heat exchanger to provide the feed stream 111. In this example, the temperature was adjusted to approximate the temperature of the water for treatment in a mining operation. Residence time in the blend tank 202 was about 15 min.

Also, in the pilot plant, the acid 106 (H₂SO₄ in the examples referred to herein) was then added to the blend tank 202 to reduce the alkalinity and pH of the feed stream 111 fed to the filtration 112 and membrane process 120, and to achieve consistent and reliable membrane operation and high overall water recoveries, WR.

The combined feed stream 110, was fed to a prefilter and then to the filtration 112 to sufficiently remove total suspended solids (TSS) from the water. Filtration recovery (FR) in the filtration 112, which included ultrafiltration (UF), in all cases was >97%, with FR values as high as 98% achieved in some cases.

The filter prior to the UF utilized a 100 μm spiral wound polypropylene cartridge. The UF utilized in the pilot plant was an INGE Dizzer 1.5 MB UF system (0.02 μm pores, 0.1 m in diameter 1.7 m in length) followed by seven 2.5″ diameter, 40″ long, NF or RO membranes (NF270 or BW30 membranes from Dupont) connected in series.

When NF membranes were utilized in the membrane treatment 120 (Example 1), a second set of seven RO membranes, a “second pass RO”, was utilized to re-process the NF permeate to produce RO permeate suitable for flushing the membranes, backwashing the UF, and for reagent make up.

An overview of the results of the treatment are provided in Table 2.

TABLE 2
High Level Overview of Pilot Plant Results (Averages)

| | | Summary of Results | | |
|---|---|---|---|---|
| | | Example 1 | Example 2 | Example 3 |
| | | Water Source | | |
| | | MCW 1 | | MCW 2 |
| Membranes | Unit | NF270 | RO: BW30 | |
| Acid type added to Tank 202 | — | H₂SO₄ | H₂SO₄ | H₂SO₄ |
| Acid added to Tank 202 | mg/L | 20 | 60 | 80 |
| Antiscalant dosage added to Stream 114 | mg/L | 2.2 | 2.6 | 2.6 |
| Membrane Recovery, MR | % | 75% | 70% | 65% |
| Overall Water Recovery, WR | % | 93% | 94.2% | 96% |
| Overall SO4 Removal | % | 86% | 93% | 95% |
| Overall TDS Removal | % | 71% | 85% | 92% |
| kg of Primary Residue Produced Stream | kg/m³ | 1.7 | 2.5 | 5.3 |
| 132 (dry) per m³ of MCW 102 Treated | | | | |

WR value excludes water losses in Filtration Recovery and membrane flushing

In Example 1, for simplicity, only chemistry and operational results from the primary stage of NF membrane operations are presented.

When the RO option was tested (Examples 2 and 3) only one set of seven RO membranes was utilized. The results shown in Tables 1 to 7 are all from the Demonstration periods, and data presented is after the chemistry of the processed brine 134 was considered to have achieved steady state concentrations of key chemical components, in particular: [N—NO₃], [Cl], [Se], [SO₄]. Again, the recycled processed brine stream 140 had similar chemistry to that of the processed brine bleed off 138 and of the processed brine 134.

Tables 1 and 2 show a summary of some of influent and effluent water chemistry, and overall water recovery obtained in the pilot plant, WR, and of the SO₄ and TDS removal achieved during piloting with MCW. Further details of experimental conditions utilized to obtain the data shown in these tables are provided below in Tables 3 to 6.

Table 1 shows the range of MCW 102 water chemistries that were tested in the pilot program. Assays of the streams 114, 124, 140 and 122 are also shown in each example (taken during the demonstration period). These are average assays of some water samples obtained during testing of the process 100 (as indicated in FIG. 1 to FIG. 3), during each Example (and in the demonstration period of operation).

A summary of operational results from the UF, NF and RO membrane treatments is set out in Table 3. Examples 1, 2, and 3 were carried out using the process shown and described herein, utilizing NF membranes in Example 1, and RO membranes in Examples 2 and 3. Demonstration phases or periods in each Example started after stable operation and water chemistry in the processed brine 134 was achieved. Thus, samples taken and analysis provided are those during the demonstration phase in which stable operation is achieved. Total duration of each Example and duration of each demonstration period is shown in Table 3.

Table 3 summarizes major operational parameters from the UF and NF and RO membrane treatments.

TABLE 3
Summary of Membrane Operational Results in Each Example

| Membrane Operational Results | Unit | Example 1 | Example 2 | Example 3 |
|---|---|---|---|---|
| Total Runtime in Each Example | d | 12 | 13 | 13 |
| Demo Runtime | h | 120 | 48 | 72 |
| Membrane Plant Demo Availability | % | 100% | 100% | 100% |
| MCW Water Treated, Stream 102 | m³/d | 8.3 | 7.8 | 7.6 |
| Total Water Flow to UF, Stream 111 | m³/d | 10.6 | 10.7 | 11.4 |
| Brine Flow, Stream 124 | m³/d | 2.7 | 3.2 | 4.1 |
| Recycled Processed Brine Stream 140 | m³/d | 2.3 | 3.0 | 3.8 |
| Fraction of Stream 134 Recycled as Stream 140 | % | 85% | 92% | 91% |
| Feed Temperature, Stream 111 | ° C. | 6 | 4 | 6 |
| UF Differential Pressure (applied pressure) | bar | 0.10 | 0.10 | 0.12 |
| UF Flux | LMH | 46 | 48 | 50 |
| UF Permeability | LMH/bar | 398 | 495 | 438 |
| Primary Membrane Recovery | % | 75% | 70% | 65% |
| Membranes Used | — | NF:NF270 | RO:BW30 | RO:BW30 |
| Membrane Differential Pressure (applied | bar | 6.6 | 14.6 | 14.7 |
| pressure) | | | | |
| Membrane Flux | LMH | 23 | 24 | 23 |
| Membrane Permeability | LMH/bar | 3.8 | 1.7 | 1.7 |

LMH = membrane flux, L/m²/h, values normalized for operational temperature

In Example 1 in the pilot plant, the UF Filtrate Stream 114 (shown in FIG. 2) was utilized for backwashing the UF, and the RO, and a fraction 210 of permeate was utilized for membrane flushing and cleaning.

Use of the fraction 210 of the RO permeate 122 for membrane flushing, cleaning and reagent preparation is not accounted for in the overall water recovery calculations shown in results from Example 1 as the pilot plant streams 316 and 322 were discarded and not incorporated into the CSTRs 214. Calculations indicate that the fraction 210 flow was close to 1% of the total permeate flow in stream 122 in the Example 1.

Similarly, referring to Examples 2 and 3, the fraction 210 of the permeate 122 that was used for backwashing the UF, and for membrane flushing and cleaning, and for reagent preparation is not accounted for in the membrane water recovery calculations shown, as the pilot plant streams 316 and 322 were discarded and not incorporated into the CSTRs 214. Calculations indicate that the fraction 210 was close to 3% of the total permeate stream 122 in Examples 2 and 3.

In a full scale plant, secondary side streams 316 and 322 may be re-incorporated into the HDS process 130, providing improved water recovery values and mass balances, as most of the water in these streams is expected to be recovered once the recycled processed brine stream 140 is blended with MCW 102 and with acid 106 and then treated again in the membrane treatment 120.

In the pilot plant a fraction 206 of the brine produced in the membrane treatment 120 was recirculated to the front end of the membrane treatment to simulate a two-stage or three-stage NF or RO operation. About 40% to about 50% of the flow of the blend 208 water fed to the membrane treatment 120 was from the fraction 206 of the brine recycled from the membrane treatment, the remainder being the stream 114 from the filtration 112 with added antiscalant 116. The remaining fraction of the produced brine 124 was fed to the HDS process 130.

Tables 4 and 5 summarize results from the HDS process including range of operational conditions and chemistry of the primary residues 132 produced by chemical assays and by quantitative x-ray diffraction (QXRD).

TABLE 4
Summary of HDS Operational Results in Each Example

| | | Example | Example | Example |
|---|---|---|---|---|
| HDS Operational Results | Unit | 1 | 2 | 3 |
| Brine Feed Rate to HDS, Stream 124 | m³/d | 2.6 | 3.2 | 4.0 |
| CSTR Reactor 1 pH | pH | 11.2 | 11.2 | 11.0 |
| CSTR Reactor 4 pH | pH | 10.6 | 10.8 | 10.6 |
| Total Retention Time in CSTR Reactors | h | 3.7 | 3.0 | 2.3 |
| HDS Reactors Solids Concentration (average of R1 & R4) | g/L | 58 | 55 | 48 |
| Hydrated Lime (estimated) per L Brine | g/L | 1.6 | 1.7 | 2.5 |
| Hydrated Lime (actual) per L of Brine | g/L | 2.4 | 3.0 | 3.5 |
| Flocculant per Solids | mg/kg | 28.7 | 48.0 | 44.2 |
| Clarifier Underflow Solids Concentration | % w/w | 51% | 34% | 33% |
| Clarifier Rise Rate | m/h | 0.4 | 0.5 | 0.6 |
| Clarifier Overflow TSS (Stream 134) | mg/L | 13 | 16 | 24 |
| Fraction of Stream 232 Recycled to Stream 218 | % | 90% | 89% | 84% |
| Fraction of Stream 232 Sent to Solids Dewatering 220 | % | 10% | 11% | 16% |
| kg of Primary Residue Produced Stream 132 (dry) per m³ | kg/m³ | 1.7 | 2.5 | 5.3 |
| of MCW 102 Treated | | | | |

TABLE 5
Chemistry and QXRD of Residues and Fraction of Se Removed in Each Example

| Primary Residue Composition | | Example | Example | Example |
|---|---|---|---|---|
| and Characteristics | Unit | 1 | 2 | 3 |
| Aragonite, CaCO₃ (QXRD) | % | 0.5 | 17.8 | 8.7 |
| Brucite, Mg(OH)₂ (QXRD) | % | 17.6 | 14.3 | 15.6 |
| Calcite, CaCO₃ (QXRD) | % | 20.1 | 4.8 | 12.4 |
| Gypsum, CaSO₄•2H₂O (QXRD) | % | 61.9 | 62.5 | 63.0 |
| Sludge Cake PSD, P75 | μm | 24.8 | 18.4 | 25.8 |
| Selenium, TCLP | mg/L | 0.3 | 0.5 | 0.4 |
| Carbon, inorganic | % | 2.5 | 2.7 | 2.4 |
| Sulphur, total | % | 10.4 | 9.5 | 9.8 |
| Calcium | % | 20.8 | 21.9 | 20.8 |
| Magnesium | % | 7.1 | 6.7 | 6.9 |
| Selenium | mg/kg | 16.7 | 28.8 | 23.0 |
| Calculated % of Se removed from MWC 102* | % | 10% | 18% | 28% |

*ratio of amount of Se (mg) in the residue to total Se (mg) in MCW 102 treated during each Demo.

The brine 124 fed to the HDS system 130 was stored in a tank with a residence time of up to 4 h. The brine 124 assays shown in Table 1 were taken from effluent from the brine storage tank, rather than from freshly produced brine. During storage of the brine 124, some CO₂ is degassed causing the pH and alkalinity to rise slightly, thus increasing LSI. Some solids precipitated in the storage tank from the brine 124, which is supersaturated, but precipitation was not significant (TSS in brine 124 fed to the HDS process was less than 10 mg/L as shown in Table 1).

In the Examples shown in the tables, the same phosphonate based antiscalant (AS) was used (Avista Vitec™ 7000) at dosages indicated in Table 2.

As an indirect indicator of the presence of the antiscalant in solution, phosphonate assay analytical procedures were used and phosphorus (P) and phosphate (PO₄) assays were used to calculate the concentration of the antiscalant in key streams. Based on solution assays for every mg/L of antiscalant added to the water there was ˜0.204 mg/L of PO₄ or ˜0.066 mg/L of P added.

As indicated above, the UF elements were periodically backwashed (generally every seven hours) with UF filtrate (in Example 1) or with RO permeate (in Examples 2 and 3), and also were periodically subjected to chemically enhanced backwash cycles (CEBs). The frequency and duration of the UF backwash cycles may be modified depending on the concentration of suspended solids and compounds present in the water fed to the UF elements.

NF and RO membranes were also periodically flushed with RO permeate; flushing was carried out for about 10 min every 24 hours or 48 hours of operation. More frequent flushing may also be used. For example, flushing may be carried out about every 12 hours for about 3 min.

All rejected water from backwashing and CEB of the UF, and for flushing of the membranes was discarded in the pilot plant. These solutions may be incorporated into the HDS process 130, by adding to one of the CSTRs 214, in a full scale operation, however.

Hydrated lime slurry was first mixed with brine 124, and with the fraction 218 of the underflow 232 recycled from the clarifier, in a lime-sludge mix tank 212 prior to being fed to the first reactor of the CSTRs 214 with the objective of producing precipitates that settle rapidly (initial settling rate >400 m³/m²/d) in the clarifier 216.

Four CSTR treatment reactors, referred to as CSTRs 214 in series were utilized. One or two reactors in the series may be bypassed depending on the target total retention time (2 h to 4 h) for the overall CSTR series. In the Examples presented, no CSTR reactors were bypassed. Variable brine flow rates were tested, resulting in residence times within the target total retention time.

In the HDS process 130, the S/L separation 216 utilized for solids settling acted as a thickener to produce a thickened underflow and a clarifier to produce a clear supernatant. The S/L separation 216 is also referred to as a clarifier.

The slurry from the last of the CSTRs 214 was flocculated with Polyclear™ 2528 reagent at a target dosage of about 10 to about 40 mg/kg solids to improve settling, and then fed to the S/L separation 216 where the solids were separated in a sludge 232.

A fraction of the sludge 232 produced from the HDS process 130 was dewatered, producing the primary residues 132. In the pilot plant, water from the dewatering 220, stream 224 was not returned to the HDS process, but may be returned to the HDS process in the full scale plant.

Table 6 summarizes NF and RO brine rejection values.

TABLE 6
Average Membrane Rejection Values in Each Example
Calculated Using Stream 114 as Feed to the Membranes 120 and Using Stream 122 as Effluent

| | | Alkalinity | Cl | N—NO₃ | SO₄ | Ca | Mg | Se |
|---|---|---|---|---|---|---|---|---|
| Example 1 | NF Rejection | 48.5% | 34.5% | 2.2% | 99.2% | 68.7% | 93.8% | 97.9% |
| Example 2 | RO Rejection | 99.1% | 98.5% | 98.8% | 99.9% | 99.8% | 99.8% | 99.9% |
| Example 3 | RO Rejection | 99.2% | 99.1% | 98.4% | 99.9% | 99.9% | 99.9% | 99.9% |

Table 7 summarizes the chemistry of the water treated and effluents produced in Example 3.

TABLE 7
Summary of Example 3 Chemical Assays and Percent Removal of Components

| | | | | | Calculated values | | Calculated Reconciled | |
|---|---|---|---|---|---|---|---|---|
| | | | | | at 96.4% WR | | values at 93.4% WR | |
| | | | | | Calculated | | Calculated | |
| | | Data from assays | | | Stream 260 | | Stream 260 | |
| | | MCW | | | (Stream 122 | Removal of | (Stream 122 | Removal of |
| | | Feed | Processed | Permeate | and 138) at | components, | and 138) at | components, |
| | Unit | 102 | Brine 138 | 122 | 96.4% WR | % | 93.4% WR | % |
| Alkalinity | mg/L | 538 | 80 | 5 | 9 | 98.6% | 10 | 98.2% |
| Conductivity | μS/cm | 3588 | 7190 | 44 | — | — | | — |
| pH | — | 7.9 | 10.5 | 5.8 | 6.0 | — | 6.1 | — |
| TDS | mg/L | 3756 | 6718 | 45 | 285 | 92.4% | 485 | 87.1% |
| TSS | mg/L | <3 | 24 | <3 | <5 | — | <5 | — |
| [Cl] | mg/L | 13.2 | 194 | 0.6 | 7.6 | 42.8% | 13.4 | −0.9% |
| [N—NO₃] | mg/L | 46 | 650 | 3.9 | 27 | 41.4% | 47 | −0.5% |
| [SO₄] | mg/L | 1894 | 1625 | 0.7 | 59 | 96.9% | 108 | 94.3% |
| [TOC] | mg/L | 1.2 | 8.2 | 0.5 | 0.8 | 34.5% | 1.0 | 15.0% |
| [Ca], total | mg/L | 408 | 1385 | 0.9 | 51 | 87.6% | 92 | 77.4% |
| [Co], total | μg/L | 0.20 | 0.50 | 0.10 | 0.11 | 42.8% | 0.13 | 36.8% |
| [Mg], total | mg/L | 365 | 80 | 0.3 | 3.2 | 99.1% | 5.6 | 98.5% |
| [Ni], total | μg/L | 32 | 2.5 | 0.5 | 0.6 | 98.2% | 0.6 | 98.0% |
| [P], total | mg/L | 0.10 | 0.02 | 0.003 | 0.004 | 96.3% | 0.004 | 95.9% |
| [K], total | mg/L | 6.3 | 49 | 3.1 | 4.8 | 24.2% | 6.1 | 2.3% |
| [Se], total | μg/L | 395 | 4282 | 0.6 | 155 | 60.8% | 283 | 28.2% |
| [Na], total | mg/L | 16 | 184 | 4.4 | 10.8 | 32.2% | 16.2 | −1.4% |
| [U], total | μg/L | 29 | 0.2 | 0.01 | 0.02 | 99.9% | 0.02 | 99.9% |
| [Zn], total | μg/L | 61 | 15 | 3.0 | 3.4 | 94.4% | 3.8 | 93.8% |

Thus, from analysis of data obtained during operation of the pilot plant, and as shown in Table 1, average water chemistry in the MCW 102 treated ranged between 345 and 538 mg/L alkalinity (as CaCO₃), [N—NO₃] ranged between 11 and 46 mg/L, [Se] ranged between 293 and 395 μg/L, and [SO₄] ranged between 758 and 1894 mg/L.

Also, as indicated by the positive LSI values in MCW 102 (LSI values were between 0.8 and 1.2), MCW is supersaturated in calcite. Also MCW 102 was undersaturated in gypsum, as indicated by Gs values less than 1 (Gs values were between 0.3 and 0.7).

Chemistry of the recycled processed brine stream 140 (equivalent to stream 134) as well as of the permeate 122 for each Example are also shown in Table 1.

Also, in Table 2, overall water recovery in the pilot plant (WR), SO₄, and TDS removal are shown in each Example. High TDS removal, for example at least 85% was achieved with RO membranes in Example 2 and Example 3.

As shown in Table 2, H₂SO₄ was added as the acid 106 in all Examples. Also, the fraction of recycled processed brine stream 140 with respect to process brine 124 produced that was blended with MCW 102 is shown in Table 3 (ranging between 85% and 92%), for each of the presented examples.

In Example 1, the final alkalinity of the blended, filtered feed 114, was 254 mg/L, with an LSI of 0.3 and a Gs of 0.5 (as shown in Table 1).

To operate Example 1 at high WR, for example, ˜93%, membrane recovery (MR) was set to a conservative 75% MR, and a large fraction, for example, ˜85%, of the processed brine 134 was recycled as the recycled processed brine stream 140.

RO membranes (BW30) were utilized in Example 2 and Example 3. RO membranes, in contrast to NF membranes utilized in Example 1, reject most of the N—NO₃ and alkalinity present in blended feed 114 to the brine 124. Membrane rejection values are shown in Table 6.

The highest purity permeate 122, was obtained with RO membranes, as shown in permeate 122 assays in Table 1 for Examples 2 and 3.

As shown in Table 1, MCW 102 in Example 3, had a high alkalinity (538 mg/L), high pH (7.9), high LSI (1.2), and high Gs (0.7).

In Example 3, the blended filtered feed 114, after acid addition and after the addition of the recycled processed brine stream 140, had a lower alkalinity (280 mg/L vs. 538 mg/L), reduced pH (7.4 vs. 7.9), reduced LSI (0.7 vs. 1.2), and increased Gs (1.1 vs. 0.7) compared to that of the MCW 102. With this water chemistry, and operating at MR of 65%, and with 91% of the processed brine 134 recycled as the recycled processed brine stream 140 (as shown in Table 3), WR of ˜96% was obtained in Example 3 as shown in Table 2.

As shown in Table 2, membrane water recovery values, MR, were only 70% and 65%, but overall WR was 94% and 96% in Examples 2 and 3 respectively. Overall, MR was set at conservative values (65% to 70%) to warrant stable membrane operation, with higher MR values possible, for example, by further adjusting acid addition, adjusting operational parameters in the HDS process and by increasing the fraction of processed brine recycled to blend tank 202.

Flowsheet performance may be modelled based on the processes disclosed herein and using commercially available software (e.g., WAVE by DuPont™) to model the treatment of the blended stream 110 in membrane based systems under various membrane configurations and operational conditions.

Utilizing RO membranes in Example 2 and Example 3, high removal of TDS, SO₄, and Se were achieved by recirculating between 91% and 92% of the processed brine 134 as the recycled processed brine stream 140.

In Example 2, [Se] in processed brine 134 reached values near 5,200 μg/L and [N—NO₃] was as high as 244 mg/L, with [SO₄] of 1850 mg/L.

In Example 3, [Se] in processed brine 134 reached values near 4,300 μg/L and [N—NO₃] was as high as 650 mg/L, with [SO₄] of 1625 mg/L.

WR higher than 96% may be consistently achieved but such values were not tested for long periods. Achievement of higher WR involves higher brine recirculation ratios, optimization of the membrane operational conditions, higher membrane applied pressures than those shown in Table 4, and further acid and antiscalant optimization.

The HDS process 130 operated well, with significant levels of gypsum, calcite, and brucite removed. The chemistry of residues is shown in Table 5.

The antiscalant was significantly removed in the first reactor of the CSTRs 214, as indicated by changes in [P] across the CSTR, without external seed material or any additional, specific antiscalant deactivation or dedicated removal process.

As shown in Table 1, [P] assays in brine 124 ranged between 0.45 and 0.53 mg/L in Examples 1, 2, and 3. In the recycled processed brine stream 140, [P] assays were close to 0.02 mg/L. Thus, the HDS process 130 effectively removed [P] from the brine 124, most likely as a result of enhanced removal of TDS from the brine, with no significant issues removing substantial levels of gypsum from the brine.

Maintaining an average solids content of 48 to 58 g/L in the CSTRs 214 assisted with antiscalant and gypsum removal in the HDS process 130.

Most of the Se present in blended feed 114 deports to brine 124.

Se removal deporting to primary residues 132 is calculated from [Se] in MCW 102, from the flow of MCW 102 treated during each demonstration period, and the [Se] and residue mass produced in each demonstration period.

As shown in Table 5, the fraction of Se removed in the residues 132 was 18% in Example 2, and 28% in Example 3. The higher the overall TDS and SO₄ removal, or the higher the residue generation per L of water treated, the higher the removal of Se in primary residues is expected.

It is expected that in a close circuit operation, recycling all secondary streams, as illustrated in FIG. 3, and recycling more than 95% of the processed brine 134 as the recycled processed brine stream 140, higher WR, and higher SO₄ and TDS removals than those achieved in Examples 1 to 3, may be possible.

Such enhanced operation, at WR>96%, may result in Se removal as high as 50% in the HDS process as more TDS and gypsum are expected to be removed from the MCW at higher WR than at the WR achieved in Examples 1 to 3.

Table 7 summarizes assay results obtained in Example 3 in the MCW 102, the recycled processed brine stream 140, and the permeate 122.

For Example 3, approximate chemistry of the effluent, which is the blend of the recycled processed brine stream 140 and the permeate 122, at the expected WR of 96.4%, was calculated and is shown alongside the expected removal of some components.

At a WR of 96.4%, the effluent 260 assays in Table 7 show significant removal of several constituents in the system compared to those originally present in MCW 102. Additional components, including K, Na, Cl, and N—NO₃ also appear to have been removed. This unexpected removal of K, Na, Cl, and N—NO₃, was at least partly due to the fact that the permeate fraction 210, which is the RO permeate utilized for membrane flushing and cleaning, was not accounted for in the WR calculations. In addition, in the Examples, the by-product streams were not returned to the process (streams 316, 322, 224) and were discarded. The constituents referred to above were therefore discarded. Significant accumulation of soluble components was also observed in the recycled processed brine stream 140 which may be accounted for in detailed mass balances that may be utilized to balance the constituents.

Considering an approximate 3% water recovery loss, which is about the fraction 210 of permeate 122 used for UF backwashing, and for membrane flushing and reagent preparation, provides a reconciled WR of 93.4% which may be considered realistic for Example 3.

The reconciled WR value in Example 3 accounts for the approximate fraction 210 of permeate that was used for UF backwashing, and for membrane flushing and reagent preparation, with streams 316 and 322 discarded after use. Thus, this reconciled WR is believed to provide an approximation of the expected WR in the pilot plant as calculated Se removal (28%) using the reconciled WR value is close to the expected Se removal (˜28%, as shown in Table 5) and the mass balance of soluble components not expected to be removed in the HDS process provides more realistic values.

Thus, using a WR of 93.4%, for Example 3, there is insignificant (<2.3%), removal of soluble components including Na, K, Cl, N—NO₃, which was expected to occur. High TDS (˜87%) and SO₄ removal (˜94%) was also calculated at this reconciled WR value.

Also, at a reconciled 93.4% WR, Se removal (˜28%) calculated from water assays is close to that obtained from residues production and water volume treated in Example 3 (˜28%) as shown in Table 5. In summary, this WR of 93.4% provides expected assays of effluent 260 (blended permeate and brine) that are considered to be more realistic than those calculated at 96.4% WR.

In Example 3, streams 134 and 122, were assayed for advanced Se speciation, with most (>99%) of the Se present in these streams as Se⁺⁶ and all other Se compounds analyzed at their analytical detection limit.

In some MCW 102 samples tested in Example 3, there was up to 0.5 mg/L Se⁺⁴ which was concentrated in brine 124, and subsequently removed in the HDS process 130. Se speciation indicated the remainder of Se in MCW 102 and processed brine 134 was present as Se⁺⁶.

Primary residues 132 TCLP test results indicated these were below hazardous waste classification limits. TCLP limit for leachable [Se] is 1 mg/L, and maximum leachable [Se] in TCLP tests was 0.5 mg/L as shown in Table 5.

Also, as seen in Table 1, other trace impurities present in MCW such as Ni, U, and Zn, largely report to the brine 124 and are significantly removed in the HDS process 130 most likely as hydroxides.

Total organic carbon, TOC, is not significantly removed in the HDS process 130. Only in Example 3, comparing TOC assays of brine 124 with those of processed brine 140, a small decrease in [TOC] across the HDS process 130, occurred.

Overall, in Examples 1, 2, and 3, there is an increase in [TOC] in the blended feed 114, from 1.1 to 1.4 mg/L in MCW 102 to 2.6 to 3.7 mg/L TOC in blended feed 114, but the increase in [TOC] in blended feed 114 over that present in MCW 102, did not appear to impair membrane performance. Membrane analysis did not indicate any significant biofouling or scaling on the UF and NF/RO membranes that was not correctable utilizing membrane maintenance procedures.

Based on the Examples provided, MCW 102 was successfully treated utilizing the present process. The process was operated at high WR of ≥93% with high SO₄ removal of ≥86% and TDS removal of ≥71%. The process produced a concentrated processed brine bleed off 138 for further treatment or management. A low TDS permeate 122 was also produced for discharge or blending with other effluents. The flowsheet demonstrated weeks of stable operation with MCW, which on average during the demonstration periods contained up to 538 mg/L alkalinity, a pH as high as 8, and up to 1894 mg/L [SO₄] with Gs as high as 0.7 and LSI as high as 1.2.

Use of RO membranes demonstrated consistent production of permeate 122 with TDS <50 mg/L and of concentrated processed brine 134 ([TDS]≥4,330 mg/L, with [Se]≥4,280 μg/L, [N—NO₃]≥209 mg/L).

Additional piloting tests using the same pilot system used in Examples 2 to 3 (with RO membranes), were carried out using another MCW from a coal mining operation. The MCW included about: 3,140 mg/L TDS, 570 μg/L Se, 86 μg/L Ni, 3.8 mg/L Cl, 150 mg/L N—NO₃, 450 mg/L Ca, 240 mg/L Mg, 460 mg/L of alkalinity as CaCO₃, pH 7.7, and 1250 mg/L SO₄, among other components.

The MCW in the additional piloting tests was successfully treated using the present process, to produce a processed brine 138 including about 12,200 mg/L TDS, 4,100 μg/L Se, 2.5 μg/L Ni, 23 mg/L Cl, 1,350 mg/L N—NO₃, 2170 mg/L Ca, 21 mg/L Mg, 34 mg/L of alkalinity as CaCO₃, pH 10.8, 1,200 mg/L SO₄ and a primary residue 132 that passed the TCLP tests, while producing an RO permeate 122 containing less than 40 mg/L TDS.

With this water chemistry, overall water recoveries, WR of 88% and sulfate removal of the order of 90% were obtained while recycling intermediate streams 316 and 322, shown in FIG. 3. Reverse osmosis Membrane recoveries, MR, were close to 72% and UF water recovery was close to 98%. About 75% of the processed brine 134 was recycled to the front end as the processed brine 140.

The additional pilot testing demonstrated that consistent, reliable operation at WR higher than 90% is possible with the MCW that included about: 3,140 mg/L TDS, 570 μg/L Se, 86 μg/L Ni, 3.8 mg/L Cl, 150 mg/L N—NO₃, 450 mg/L Ca, 240 mg/L Mg, 460 mg/L of alkalinity as CaCO₃, pH 7.7, and 1250 mg/L SO₄, among other components achieving [N—NO₃]>2,500 mg/L in the processed brine 134 and recycling up to 95% of the processed brine 134 to the front end (as the processed brine 140).

The above-described embodiments of the application and the examples are examples only. Alterations, modifications, and variations can be applied to the particular embodiments by those skilled in the art without departing from the scope of the application.

What is claimed is:

1. A process for treating Mine Contact Water (MCW), the process comprising:
providing the MCW to a feed stream;
adding acid to the feed stream to provide a reduced pH and alkalinity feed stream;
subjecting the reduced pH and alkalinity feed stream to filtration and a membrane treatment to separate the reduced pH and alkalinity feed stream into permeate and brine;
subjecting the brine to a high density sludge (HDS) process to produce a processed brine and residues;
recycling a majority of the processed brine to the feed stream;
separating a minor fraction of the processed brine to provide a bleed off of the processed brine prior to the recycling;
subjecting the bleed off of the processed brine to a subsequent treatment to remove at least some contaminants.

2. The process according to claim 1, wherein adding the acid to the feed stream provides a reduced pH and reduced alkalinity feed stream.

3. The process according to claim 1 or claim 2, wherein the at least some contaminants comprises at least some Se and NO₃.

4. The process according to any one of claims 1 to 3, comprising subjecting the bleed off of the processed brine bleed off to subsequent biological treatment.

5. The process according to claim 1, comprising subjecting the bleed off of the processed brine to treatment to produce chemical products for use in one or more of fertilizer and explosives.

6. The process according to claim 3, comprising subjecting the bleed off of the processed brine to subsequent treatment comprises subjecting the bleed off of the processed brine to one or both of physical-chemical treatment and evaporation/crystallization to produce products including a majority of the Se and NO₃.

7. The process according to claim 1, comprising subjecting the feed stream to one or both of microfiltration and ultrafiltration prior to the membrane treatment.

8. The process according to claim 1, wherein the membrane treatment comprises the use of at least one of reverse osmosis and nanofiltration membranes.

9. The process according to claim 1, wherein adding acid comprises controlling addition of at least one of H₂SO₄, HCl, and HNO₃.

10. The process according to claim 1, wherein subjecting the bleed off of the processed brine to a subsequent treatment comprises blending the bleed off of the processed brine with some or all of the permeate from the membrane treatment and with MCW.

11. The process according to claim 10, wherein subjecting the bleed off of the processed brine to a subsequent treatment comprises treating the blend of the bleed off with some or all of the permeate and with MCW in an active water treatment facility (AWTF).

12. The process according to claim 10, wherein subjecting the bleed off of the processed brine to a subsequent treatment comprises treating the blend of the bleed off with MCW and some or all of the permeate in a Saturated Rock Fill facility (SRF).

13. The process according to claim 1, wherein a fraction of residual antiscalant and a fraction of the inorganic compounds present in the brine are removed in the HDS process, producing residues including the fraction of the residual antiscalant and the fraction of the inorganic compounds.

14. The process according to claim 1, wherein a plurality of TDS, alkalinity, SO₄, Ni, Co, U, Zn, and Se, are partially removed from the MCW in the HDS process.

15. The process according to claim 14, wherein selenium present in the brine is partially removed in the HDS process and reports to the residues.

16. The process according to claim 15, wherein about 10% to about 50% of the selenium present in the brine is removed in the HDS process and reports to the residues.

17. The process according to claim 1, wherein the MCW has a pH of about 6.5 to about 8.5.

18. The process according to claim 1, wherein the MCW has a sulphate concentration of about 550 mg/L to about 2200 mg/L, with Gypsum supersaturation, Gs, values between 0.2 and 1.

19. The process according to claim 1, wherein the MCW has an alkalinity as CaCO₃ between 50 mg/L to about 600 mg/L.

20. The process according to claim 1, wherein the MCW is process water from a mineral processing operation and has Gypsum supersaturation values between 0.2 and 2.

21. The process according to claim 1, wherein the HDS process comprises a plurality of continuous stirred-tank reactors (CSTRs), a lime-sludge mix tank, and a thickener/clarifier.

22. The process according to claim 20, wherein solids content in the CSTRs ranges between 30 and 120 g/L.

23. The process according to claim 20, wherein pH in each of the CSTRs range between 10.2 and 11.4, with a first one of the CSTR's having the highest pH of the CSTRs.

24. The process according to claim 1, wherein the MCW comprises ground water from a mining operation.

25. The process according to claim 1, wherein the MCW comprises process water from a mining operation and/or from a mineral process operation.

26. The process according to claim 1, wherein the MCW comprises run-off water after contact with rock dumps from mining of coal.

27. The process according to claim 1, wherein the MCW comprises run-off water after contact with rock dumps from mining of zinc or copper.
